(19) United States
(12) Patent Application Publication
(10) Pub. No.: US 2011/0180335 A1
(43) Pub. Date: Jul. 28, 2011

(54) All-Terrain Vehicle and Method of Increasing Passability Thereof

(76) Inventors: Mikhail V. Ivankov, Dubna (RU); Maksim M. Ivankov, Dubna (RU)

(21) Appl. No.: 12/913,377

(22) Filed: Oct. 27, 2010

(30) Foreign Application Priority Data
Oct. 29, 2009 (RU) 2009139842

(51) Int. Cl. B62D 53/00; B60K 8/00; B23P 17/00

(52) U.S. Cl. 180/14.4; 180/291; 29/428

(57) ABSTRACT

The invention relates to the automotive technique. Its use while creating new and improving current all-terrain vehicles allows to ensure the achievement of the technical result in the form of simplifying the all-terrain vehicle transmission, increasing the reliability, and decreasing the wheels surface wear, specifically for wheels having a non-hub drive. For this purpose, an all-terrain vehicle comprises: an engine transmission section; a pair of caterpillar drives from each of the side faces of the engine transmission section; a support frame provided with at least two rotatably mounted axles, on each of which at least two wheels are fixed so as the distance between the maximal radius circles of those wheels at each of those axles corresponding approximately the distance between the midline of the caterpillar drives; wherein the engine transmission section being fixed on the support frame so as a contact pattern of each of the caterpillar drives with a surface of the corresponding wheel being not less than a contact pattern of the lower portion of this wheel with the movement supporting surface.

### RELATED APPLICATIONS

This application claims priority to Russian application RU 2009139842 filed on Oct. 29, 2009, which is incorporated herein by reference in its entirety.

### FIELD OF THE INVENTION

This invention relates to the automotive technique, and more particularly, to the method for increasing the cross-country ability all-terrain vehicle and to corresponding all-terrain vehicle.

### BACKGROUND OF THE INVENTION

At present, various methods for increasing the cross-country ability of all-terrain vehicles are known.

Known is the method for increasing the cross-country ability, pursuant to which method an all-terrain vehicle is provided with tracks in the form of pneumatic cushion (RU 2119438 C1, publ. on Sep. 27, 1998). Another technical solution consists in arranging the engine transmission compartment within a pneumatic envelope (RU 2284941 C1, publ. on Oct. 10, 2006).

The disadvantage of those technical solutions consists in complexity of their structure and manufacture technology, a great price and maintenance costs, insufficient life time of the main assemblies, and low reliability indices.

Also known is the method for increasing the cross-country ability of all-terrain vehicle, in which method the wheels with low-pressure tires are employed (RU 53999 U1, publ. on Jun. 10, 2006, and RU 64140 U1, publ. on Jun. 27, 2007).

The disadvantage of those technical solutions consists in that, in order for driving the pneumatic wheels having a great diameter, as well as for ensuring the required transmission reliability indices, complex and massive assemblies of the transmission are employed, such as portal tractor reduction axles, torque dividers, onboard reducing gears, overload controlled and uncontrolled clutches, etc., which increases the total weight of the vehicle, lowers the transmission performance factor, increases the fuel consumption, and decreases the reliability indices.

Also known is the method for increasing the cross-country ability of all-terrain vehicle, in which method a vehicle is mounted onto the support frame having the caterpillar drive, the drive mechanism of the vehicle rotating a roller to which a track being pressed, in turn, (US 2008/0268728 A1, publ. on Oct. 30, 2008).

The disadvantage of this technical solution consists in a low reliability due to the fact that the track is pressed to the roller in a small area whereupon a great pressure force is necessary resulting in a rapid wear.

### SUMMARY OF THE INVENTION

The present invention is directed at overcoming the indicated disadvantages of the known technical solutions and ensures the achievement of the technical result in the form of simplifying the all-terrain vehicle transmission, increasing the reliability, and decreasing the wheels surface wear, specifically for wheels having a non-hub drive.

For this purpose, the first object of the present invention provides a method for increasing the cross-country ability of all-terrain vehicle comprising at least an engine transmission section and a pair of caterpillar drives from each of the side faces of the engine transmission section, the method including steps of: mounting the engine transmission section on a support frame provided with at least two rotatably mounted axles; fixing at least two wheels on each of those axles so as the distance between the maximal radius circles of those wheels at each of those axles corresponding approximately the distance between the midline of the caterpillar drives; fixing the engine transmission section on the support frame so as a contact pattern of each of the caterpillar drives with a surface of the corresponding wheel being not less than a contact pattern of the lower portion of this wheel with the movement supporting surface.

An additional feature of the method according to the present invention is in that rubber-cord tracks are used as the caterpillar drives.

One more additional feature of the method according to the present invention is in that, in order for increasing the contact pattern of the caterpillar drives with the surface of the corresponding wheel, pressing rollers are disposed in the engine transmission section so as to increase the contact pattern of each of the caterpillar drive with each of the wheels. In another embodiment for the same purpose are used the caterpillar drives having a convex profile faced to the wheels. In one more embodiment, pneumatic wheels are used as the wheels. In this case, the pneumatic wheels have the diameter not less than 1 m.

One more additional feature of the method according to the present invention is in that two all-terrain vehicles are joined by means of the transmission from the engine transmission section of the first all-terrain vehicle to the transmission section of the second all-terrain vehicle, the joint being configured for allowing the second all-terrain vehicle to deviate from the movement direction of the first all-terrain vehicle for ensuring a turn of the joined all-terrain vehicles.

In order for achieving the same technical result, the second object of the present invention provides an all-terrain vehicle comprising: an engine transmission section; a pair of caterpillar drives from each of the side faces of the engine transmission section; a support frame provided with at least two rotatably mounted axles, on each of which at least two wheels are fixed so as the distance between the maximal radius circles of those wheels at each of those axles corresponding approximately the distance between the midline of the caterpillar drives; wherein the engine transmission section being fixed on the support frame so as a contact pattern of each of the caterpillar drives with a surface of the corresponding wheel being not less than a contact pattern of the lower portion of this wheel with the movement supporting surface.

An additional feature of this all-terrain vehicle according to the present invention is in that the caterpillar tracks are made in the form of rubber-cord drives.

One more additional feature of this all-terrain vehicle is in that, in order for increasing the contact pattern of the caterpillar drives with the surface of the corresponding wheel, press rollers are disposed in the engine transmission section so as to increase the contact pattern of each of the caterpillar drive with each of the wheels. In another embodiment for the same purpose are used the caterpillar drives having a convex profile faced to the wheels. In one more embodiment, pneumatic wheels are used as the wheels. In this case, the pneumatic wheels have the diameter not less than 1 m.

One more additional feature of this all-terrain vehicle is in comprising further a same second all-terrain vehicle joined with the first all-terrain vehicle by means of the transmission from the engine transmission section of the first all-terrain vehicle to the transmission section of the second all-terrain vehicle, the joint being configured for allowing the second all-terrain vehicle to deviate from the movement direction of the first all-terrain vehicle for ensuring a turn of the joined all-terrain vehicles.

### BRIEF DESCRIPTION OF THE DRAWINGS

The invention is illustrated with reference to the drawings in which the same elements are designated by the same reference numbers.

FIG. 1 shows the side elevation view of the all-terrain vehicle of the present invention, in which vehicle is implemented the method for increasing the cross-country ability according to the present invention.

FIG. 2 shows the front elevation view of the all-terrain vehicle shown in FIG. 1.

FIG. 3 shows two joined all-terrain vehicles shown in FIG. 1.

### DETAILED DESCRIPTION OF EMBODIMENTS

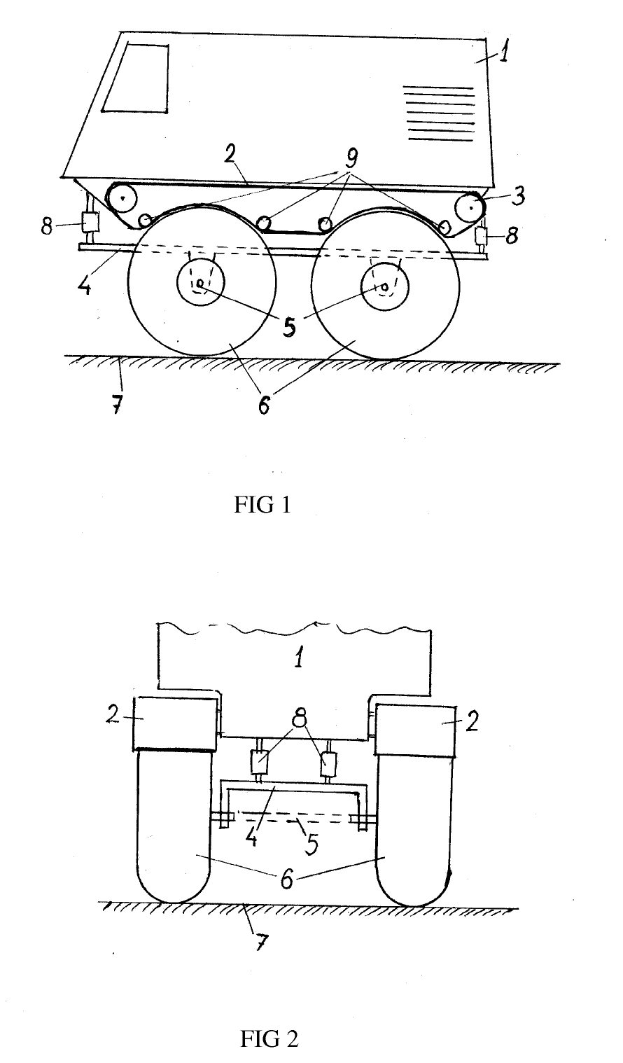

As shown in FIG. 1, the all-terrain vehicle of the present invention comprises an engine transmission section 1 which is an independent vehicle, for example, a tracked cross-country vehicle or a car. Alternatively, the engine transmission section 1 could be designed especially for the all-terrain vehicle of the present invention. It is essential that the engine transmission section 1 has, as is clear from its name, an engine (motor) of any type, for example, a combustion engine, a diesel engine, an electrical engine, etc., and a transmission to at least one of its axles for transmitting a rotation from the engine. At the drawing, the rear axle is depicted as an example of such one axle, but this is not necessarily so, and the driving axle can be, for example, the front axle, or both axles, the front and rear, can be the drive ones. In the presence of more than two axles in the engine transmission section 1, any or all of those axles could be the drive ones. It is clear that the engine transmission section 1 is enclosed in a casing and has a driver's cab nominally shown to the left in FIG. 1; however the presence of the casing and driver's cab is not obligatory.

The engine transmission section 1 has, at the side faces thereof, a pair of caterpillar drives made, in the preferred embodiment, in the form of rubber-cord tracks 2 (only the left, when being in motion, track of the all-terrain vehicle, while the right track is hidden from viewing). It is supposed in FIG. 1 that the rubber-cord track 2 is driven by a driving wheel 3 disposed at the rear axle, although, as is noted above, this is not essential, and the driving wheel 3 can be disposed at the front axle, and even at all axles of the engine transmission section 1 (in FIG. 1 are shown only two axles, but this is an illustrative example only). It should be noted that the caterpillar drives could be made in the form of conventional track consisting of metal links.

The engine transmission section 1 is mounted on the support frame 4 which is provided with at least two rotatably mounted axles 5. At least two wheels 6 are fixed at each of those axles 5 so as the distance between the maximal radius circles of said wheels 6 at each of said axles 5 corresponds approximately the distance between the midline of the rubber-cord tracks 2 (see FIG. 2). The number of the wheels 6 at each axle 5, as well as the number of the axles 5 themselves, can exceed two. It is only important that at least one pair of the wheels 6 at each axle 5 are disposed under the respective rubber-cord tracks 2 of the all-terrain vehicle.

The engine transmission section 1 is fixed on the support frame 4 so as a contact pattern of each of the rubber-cord tracks 2 (in general, each of the caterpillar drives) with a surface of the corresponding wheel 6 is not less than a contact pattern of the lower portion of this wheel 6 with the movement supporting surface 7. This is achieved by any known means, for example, by hold-downs 8 that could be of any known type. For example, those hold-downs could be mechanical ones in the form of four threaded rods (bolts) with screws via the through-holes or lugs in the support frame 4 and engine transmission section 1. Alternatively, the hold-downs 8 could be of a pneumatic or hydraulic type. In this case, on the support frame are mounted not less than four hold-down clamps in the form of letters Π or Γ, which upper horizontal shelves come out beyond the frame of the engine transmission section 1. Pneumocushions (pneumojacks) or pneumo- or hydrocylinders are mounted between the horizontal shelves of the hold-down clamps and the frame of the engine transmission section 1. While inflating, i.e., during increasing the vertical size of the preumocushion or cylinder, the engine transmission section 1 would be pressed to the support frame 4.

In another embodiment of the present invention, pressing rollers 9 are disposed in the engine transmission section so as to increase the contact pattern of each of the rubber-cord tracks 2 with each of the wheels 6.

In one more embodiment of the present invention, the rubber-cord tracks 2 have a convex (for example, semi-circular or triangle) profile faced to the wheels 6.

In one more embodiment of the present invention, pneumatic wheels are used as the wheels 6, which diameter can be great enough, for example, not less than 1 m. In this case, if each axle 5 is made without the portion shown by the dotted line in FIG. 2, it is possible to ensure a very great clearance of the all-terrain vehicle. The pneumatic wheels are mounted at hollow discs-barrels having car hubs at each side or central axle at conical bearings. Comparative data for this case are summarized in the following Table where the clearance size is assumed to be equal 0.75 of the diameter of the used wheels.

| Wheel sizes, mm | Wheel volume, m³ | Vehicle clearance, mm |
|---|---|---|
| 1100 × 500 | 0.45 | 825 |
| 1320 × 600 | 0.8 | 990 |
| 1450 × 600 | 1.0 | 1080 |
| 1700 × 600 | 1.35 | 1275 |

In the latter instance (when making the axles 5 without the portion shown in dotted line in FIG. 2), the all-terrain vehicle turns are ensured by simply stopping the movement of one of the rubber-cord tracks 2.

When moving, the rubber-cord tracks 2 of the engine transmission section 1 are driven by the driving wheel 3 conversely in comparison with the self-operated movement of the engine transmission section 1. In this case, as is clear from FIG. 1, the rubber-cord tracks 2 encircle the wheels 6 with a great enough contact pattern, and the wheels 6 rotate in the opposite direction, i.e., produce a forward movement of the support frame 4. The wheels 6 are supported in this case by any supporting surface whether it is ground, snow, water, etc. In the case of moving by water, the most preferable wheels are pneumatic tires having a great diameter (more than 1 m), which gives the floatability to the all-terrain vehicle of the present invention.

Since the rubber-cord tracks 2 have a great contact pattern with each wheel 6, the frictional force therebetween appears to be enough for transmitting the moment of movement from the rubber-cord tracks 2 to the wheels 6. At the same time, such a great contact pattern does not lead to an increased wear of the surface of the wheel 6, as in the case of the roller drive. Hence, reducing the wear of the surface of the wheel 6 is ensured.

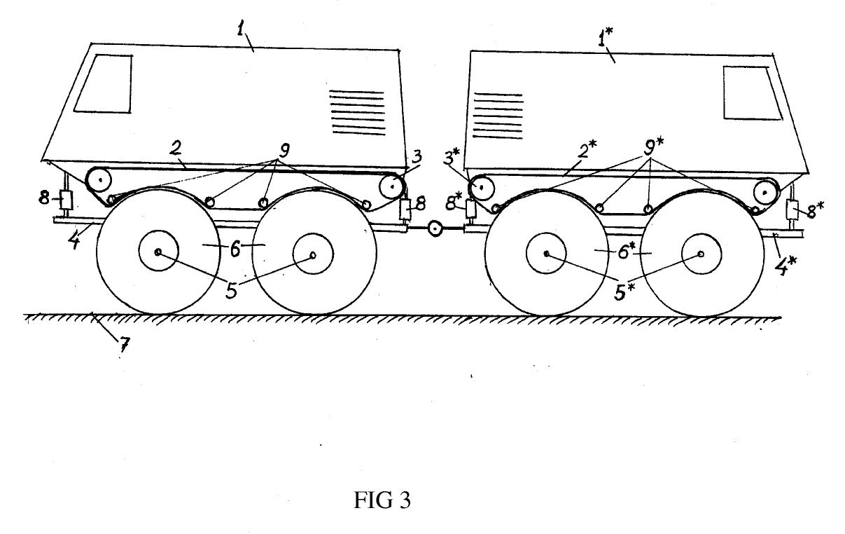

FIG. 3 shows the all-terrain vehicle consisting of two identical sections according to FIGS. 1, 2. In order for distinguishing elements of the second all-terrain vehicle from the same elements of the first all-terrain vehicle, the corresponding reference numbers are provided with asterisks. In this case, both all-terrain vehicles are joined by means the transmission from the engine transmission section 1 of the first all-terrain vehicle top the transmission section 1* of the second all-terrain vehicle (not shown), the joint 10 being configured for allowing the second all-terrain vehicle to deviate from the movement direction of the first all-terrain vehicle for ensuring a turn of the joined all-terrain vehicles.

The present invention has been described and illustrated by examples of embodiments thereof, which example are not limiting. The scope of the present invention is defined only by the following claims taking into account equivalents thereof.

1. A method for increasing the cross-country ability of all-terrain vehicle comprising at least an engine transmission section and a pair of caterpillar drives from each of the side faces of the engine transmission section, the method including steps of:
mounting said engine transmission section on a support frame provided with at least two rotatably mounted axles;
fixing at least two wheels on each of said axles so as the distance between the maximal radius circles of said wheels at each of said axles corresponding approximately the distance between the midline of said caterpillar drives;
fixing said engine transmission section on said support frame so as a contact pattern of each of said caterpillar drives with a surface of the corresponding wheel being not less than a contact pattern of the lower portion of this wheel with the movement supporting surface.

2. The method according to claim 1, wherein rubber-cord drives are used as said caterpillar tracks.

3. The method according to claim 1, wherein pressing rollers are disposed in the engine transmission section so as to increase the contact pattern of each of said caterpillar drives with each of said wheels.

4. The method according to claim 1, wherein said caterpillar drives having a convex profile faced to the wheels are used.

5. The method according to claim 1, wherein pneumatic wheels are used as said wheels.

6. The method according to claim 5, wherein the pneumatic wheels have the diameter not less than 1 m.

7. The method according to claim 1, wherein two said all-terrain vehicles are joined by means of the transmission from said engine transmission section of the first all-terrain vehicle to the transmission section of the second all-terrain vehicle, said joint being configured for allowing the second all-terrain vehicle to deviate from the movement direction of the first all-terrain vehicle for ensuring a turn of the joined all-terrain vehicles.

8. An all-terrain vehicle comprising:
an engine transmission section;
a pair of caterpillar drives from each of the side faces of said engine transmission section;
a support frame provided with at least two rotatably mounted axles, on each of which at least two wheels are fixed so as the distance between the maximal radius circles of said wheels at each of said axles corresponding approximately the distance between the midline of said caterpillar drives;
wherein said engine transmission section being fixed on said support frame so as a contact pattern of each of said caterpillar drives with a surface of the corresponding wheel being not less than a contact pattern of the lower portion of this wheel with the movement supporting surface.

9. The all-terrain vehicle according to claim 8, wherein said caterpillar tracks are made in the form of rubber-cord drives.

10. The all-terrain vehicle according to claim 8, wherein press rollers are disposed in said engine transmission section so as to increase the contact pattern of each of said caterpillar drive with each of said wheels.

11. The all-terrain vehicle according to claim 8, wherein said caterpillar drives are made having a convex profile faced to said wheels.

12. The all-terrain vehicle according to claim 8, wherein pneumatic wheels are used as said wheels.

13. The all-terrain vehicle according to claim 12, wherein said pneumatic wheels have the diameter not less than 1 m.

14. The all-terrain vehicle according to claim 8, comprising further a same second all-terrain vehicle joined with the first all-terrain vehicle by means of the transmission from said engine transmission section of the first all-terrain vehicle to the transmission section of the second all-terrain vehicle, said joint being configured for allowing the second all-terrain vehicle to deviate from the movement direction of the first all-terrain vehicle for ensuring a turn of the joined all-terrain vehicles.
